(19) United States
(12) Patent Application Publication
(10) Pub. No.: US 2017/0271946 A1
(43) Pub. Date: Sep. 21, 2017

(54) ELECTRIC MOTOR AND FAN ASSEMBLY USING THE SAME

(71) Applicant: Johnson Electric S.A., Murten (CH)

(72) Inventors: Yue LI, Hong Kong (CN); Chui You ZHOU, Shenzhen (CN); Yong WANG, Shenzhen (CN); Wei ZHANG, Shenzhen (CN); Xiao Ning ZHU, Shenzhen (CN); Hong Liang YI, Shenzhen (CN); Yong Gang ZHANG, Shenzhen (CN); Ya Ming ZHANG, Shenzhen (CN)

(21) Appl. No.: 15/459,882

(22) Filed: Mar. 15, 2017

(30) Foreign Application Priority Data
Mar. 18, 2016 (CN) 2016 1015 7024.7
May 17, 2016 (CN) 2016 1033 2939.7

(51) Int. Cl. H02K 7/108; F04D 25/06; H02K 7/118; F04D 17/16

(52) U.S. Cl. CPC H02K 7/108; F04D 17/16; F04D 25/06; H02K 7/118

(57) ABSTRACT

An electric motor includes a stator and a rotor rotatably mounted to the stator. The rotor includes a rotary shaft, a rotor main body attached around the rotary shaft, the rotor main body being rotatable under the interaction between the rotor main body and the stator when the winding is energized. The rotor main body and the rotary shaft are in a loose fitting with each other to allow a rotation speed difference being existed between the rotor main body and the rotary shaft during startup of the rotor. A time-delayed synchronization mechanism is connected between the rotary shaft and the rotor main body and configured to eliminate, with time delay, the rotation speed difference between the rotor main body and the rotary shaft.

### CROSS REFERENCE TO RELATED APPLICATIONS

This non-provisional patent application claims priority under 35 U.S.C. §119(a) from Patent Application No. 201610157024.7 filed in The People's Republic of China on Mar. 18, 2016; and Patent Application No. 201610332939.7 filed in The People's Republic of China on May 17, 2016.

### FIELD OF THE INVENTION

This invention relates to motors, and in particular, to a motor which allows for a rotation speed difference between a rotor main body and a rotary shaft of a rotor.

### BACKGROUND OF THE INVENTION

Synchronous motors may experience startup failure or stall when the rotational inertia of the load is overlarge. One solution developed in the art is to increase the performance of the motor. However, increasing the performance of the synchronous motor significantly increases the size and weight of the motor.

### SUMMARY OF THE INVENTION

Thus, there is a desire for a motor that can reduce the occurrence of motor startup failure or stall.

The present invention provides a motor including a stator and a rotor. The rotor is rotatably mounted to the stator. The rotor includes a rotary shaft, a rotor main body attached around the rotary shaft, the rotor main body being rotatable under the interaction between the rotor main body and the stator when the winding is energized. The rotor main body and the rotary shaft are in a loose fitting with each other to allow a rotation speed difference being existed between the rotor main body and the rotary shaft during startup of the rotor. A time-delayed synchronization mechanism is connected between the rotary shaft and the rotor main body and configured to eliminate, with time delay, the rotation speed difference between the rotor main body and the rotary shaft.

Preferably, the time-delayed synchronization mechanism is radially located between the rotary shaft and the rotor main body.

Preferably, the time-delayed synchronization mechanism is located axial outside of the rotor main body.

Preferably, the time-delayed synchronization mechanism includes a buffering member with a shape restoring characteristic, the buffering member comprising a first end connected to the rotary shaft for synchronization rotation with the rotary shaft and a second end connected to the rotor main body for synchronization rotation with the rotor main body.

Preferably, the time-delayed synchronization mechanism further comprises a connecting member fixed to the rotary shaft, and the first end of the buffering member is connected to the connecting member for synchronous rotation therewith.

Preferably, the connecting member is an annular plate fixed around the rotary shaft, and the buffering member is movably attached around the rotary shaft and is axially located between the connecting member and the rotor main body.

Preferably, the buffering member is a rubber sleeve or spring movably attached around the rotary shaft.

Preferably, there are two time-delay synchronization mechanisms mounted to two ends of the rotor main body, respectively.

Preferably, the rotary shaft is supported by two bearings for rotation relative to the stator, and the rotor main body and the time-delayed synchronization mechanism are located between the two bearings or outside the two bearings.

Preferably, the rotor main body comprises a rotor core and a permanent magnet fixed to the rotor core.

Preferably, the mounting member is a rotor core made of soft magnetic material.

Preferably, the motor is a single phase motor.

Preferably, the stator comprises an upper support bracket and a lower support bracket, the rotary shaft is supported by the upper support bracket and the lower support bracket for rotation relative to the stator, and the rotor main body and the time-delayed synchronization mechanism are located between the upper support bracket and the lower support bracket.

Preferably, the stator comprises a stator core and a stator winding mounted around the stator core. The stator core comprises at least two pole portions, and each pole portion comprises a pole shoe. The rotor main body is disposed in a space cooperatively defined by the pole shoes of the at least two pole portions, and the upper support bracket and the lower support bracket are mounted to two axial sides of the stator core, respectively.

Preferably, the buffering member is a helical spring, the rotor main body comprises a cylindrical hollow portion for receiving the spring therein.

Preferably, the connecting member defines a groove or slot for engaging with a first end of the helical spring, and the rotor main body defines another groove or slot for engaging with a second end of the helical spring.

Preferably, the time-delayed synchronization mechanism comprises a buffering member movably attached around the rotary shaft, and a damping member movably attached around the buffering member, the damping member being radially located between buffering member and the rotor main body.

Preferably, the rotor main body comprises permanent magnets and a cylindrical support member for supporting and fixing the permanent magnets thereon, the buffering member and the damping member being located within the support member.

The present invention further provide a fan assembly which comprises a fan and an electric motor. The motor comprises a stator comprising a stator core and a winding wound on the stator core; and a rotor rotatably mounted to the stator. The rotor comprises a rotary shaft connected to the fan for driving the fan to synchronization rotate therewith; a rotor main body attached around the rotary shaft, the rotor main body and the rotary shaft being in a loose fit with each other thus allowing a rotation speed difference therebetween; and a time-delayed synchronization mechanism located between the rotor main body and the rotary shaft, one end of the time-delayed synchronization mechanism being connected to the rotor main body, and the other end of the time-delayed synchronization mechanism being connected to the rotary shaft, for synchronizing with time delay rotation speeds of the rotor main body and the rotary shaft.

Preferably, the motor is a single phase motor.

Preferably, the area occupied by the fan in a plane perpendicular to the rotary shaft of the rotor is greater than twice of the area occupied by the motor in another plane perpendicular to the rotary shaft of the rotor.

According to the embodiments of the present invention, the rotor main body of the motor is rotatable relative to the rotary shaft, and the time-delayed synchronization mechanism is connected between the rotary shaft and the rotor main body for synchronizing, with time delay, the rotation speeds of the rotary shaft and the rotor main body, which can effectively eliminate or reduce the occurrence of motor startup failure or stall.

### BRIEF DESCRIPTION OF THE DRAWINGS

These and other features of the present invention will become readily apparent upon further review of the following specification and drawings. The figures are for the purposes of illustration only and should not be regarded as limiting. The figures are listed below.

FIG. 1 illustrates a motor according to one embodiment of the present invention.

FIG. 2 is an exploded view of the motor of FIG. 1.

FIG. 3 illustrates a stator of the motor of FIG. 1.

FIG. 4 illustrates a rotor of the motor of FIG. 1.

FIG. 5 is a sectional view of the rotor of FIG. 4.

FIG. 6 illustrates a motor according to a second embodiment of the present invention.

FIG. 7 is an exploded view of the motor of FIG. 6.

FIG. 8 illustrates a fixing member of the motor of FIG. 6.

FIG. 9 illustrates a fan assembly employing the motor of the present invention.

FIG. 10 illustrates the fan of the fan assembly of FIG. 9 assembled with the motor of FIG. 1.

FIG. 11 illustrates the fan of the fan assembly of FIG. 9 assembled with the motor of FIG. 6.

FIGS. 12-18 illustrates a rotor of a motor in accordance with a third embodiment of the present invention.

### DETAILED DESCRIPTION OF THE PREFERRED EMBODIMENTS

### First Embodiment

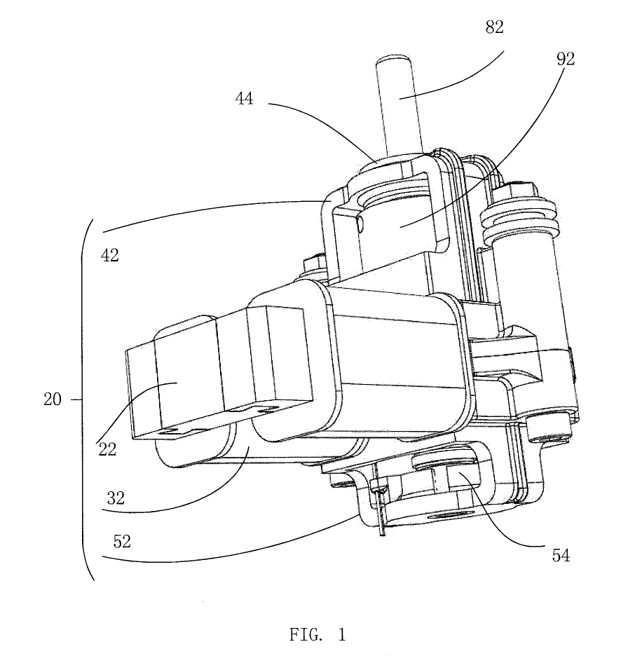

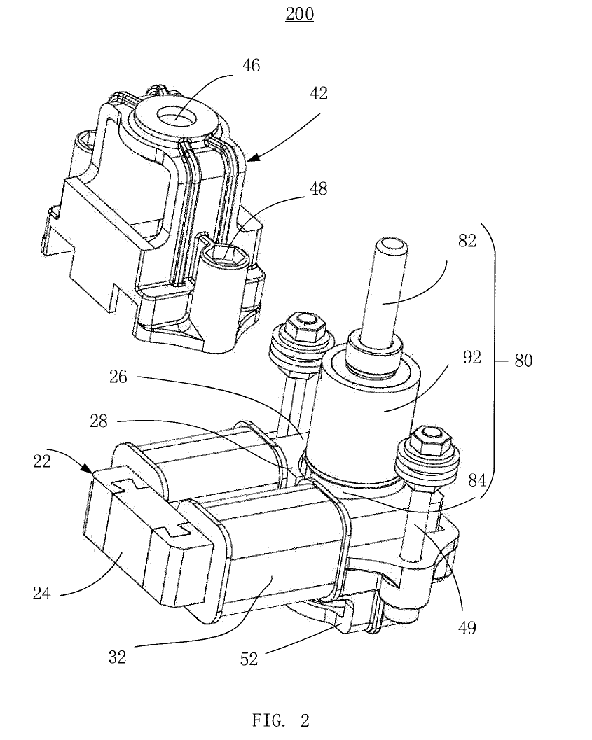

Referring to FIG. 1 and FIG. 2, a motor 200 in accordance with one embodiment of the present invention includes a stator 20 and a rotor 80. The rotor is rotatably mounted to the stator 20 for rotation relative to the stator 20.

The rotor 80 includes a rotary shaft 82, a rotor main body 84, and a time-delayed synchronization mechanism 92. The rotor main body 84 is attached around the rotary shaft 82. The rotor main body 84 is capable of rotation under the driving of the electromagnetic force of the stator 20. The rotor main body 84 and the rotary shaft 82 are in a sliding fit with each other and, as a result, a rotation speed difference exists between the rotor main body 84 and the rotary shaft 82 during the course of starting or stopping.

The time-delayed synchronization mechanism 92 is also attached around the rotary shaft 82. One end of the time-delayed synchronization mechanism 92 is fixed to the rotary shaft 82 for synchronous rotation with the rotary shaft 82, and the other end is fixed to the rotor main body 84 for synchronous rotation with the rotor main body 84. That is, the time-delayed synchronization mechanism 92 acts to eliminate, with time delay, the rotation speed difference between the rotor main body 84 and the rotary shaft 82.

The stator 20 includes an upper support bracket 42 and a lower support bracket 52 for supporting the rotary shaft 82 such that the rotor 80 is capable of rotation relative to the stator 20. Preferably, the rotor main body 84 and the time-delayed synchronization mechanism 92 are located between the upper support bracket 42 and the lower support bracket 52. That is, the time-delayed synchronization mechanism 92 is not exposed to the outside of the stator 20. Therefore, the motor 200 of the present invention can be connected to a load or a speed reduction mechanism like a conventional motor.

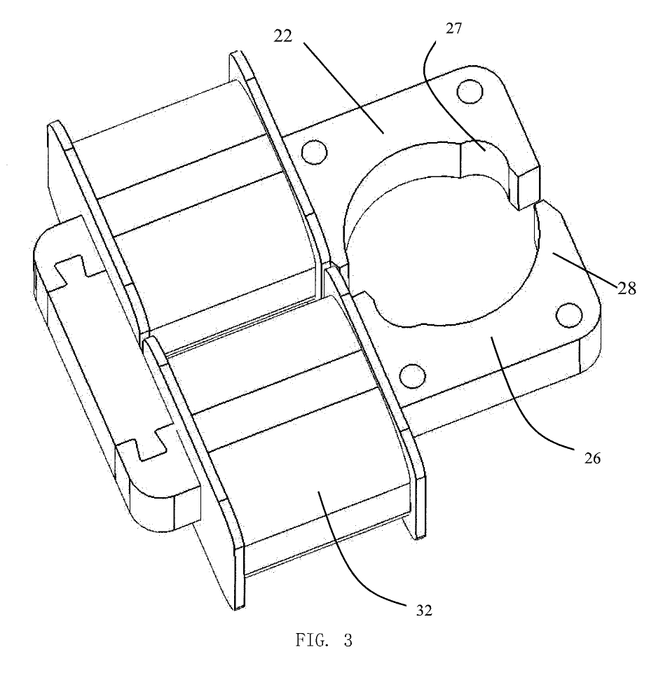

In this embodiment, the motor 200 is a single phase synchronous motor. The stator 20 includes a stator core 22, a winding 32 wound around the stator core 22, and the upper support bracket 42 and lower support bracket 52 respectively mounted to two axial sides of the stator core 22. The upper support bracket 42 and the lower support bracket 52 are interconnected through fixing members 49. In particular, the upper support bracket 42 has axial connecting holes 48 for allowing the fixing members 49 to pass therethrough, and the lower support bracket 52 have corresponding axial connecting holes for allowing the fixing members 49 to pass therethrough. Bearing seats 44, 54 are disposed in the upper support bracket 42 and the lower support bracket 52, respectively. Bearings 46, 56 (FIG. 3) are mounted in the bearing seats 44, 54, respectively, for supporting the rotary shaft 82 of the rotor 80. The rotor main body 84 and the time-delayed synchronization mechanism 92 are located between the two bearings 46, 56.

Referring to FIG. 3, the stator core 22 includes a U-shaped core 24, and two pole portions 26 at an open end of U-shaped core 24. The two pole portions 26 are opposed to each other. Each pole portion 26 has a pair of pole shoes 28 extending from two sides of the pole portion 26. The arc inner surfaces of the pole shoes 28 of each pole portion 26 are connected to each other to form a pole face. The pole face of each pole portion 26 has a positioning groove 27 in order to make the rotor capable of stopping at a position offset from a dead point position. A dead point position refers to a position of the rotor where a center line of the rotor magnetic pole and a center line of the stator pole portion are aligned with each other. The rotor main body 84 is received in a space defined by the pole shoes 28 of the two pole portions 26, such that the rotor main body 84 can rotate about the rotary shaft 82.

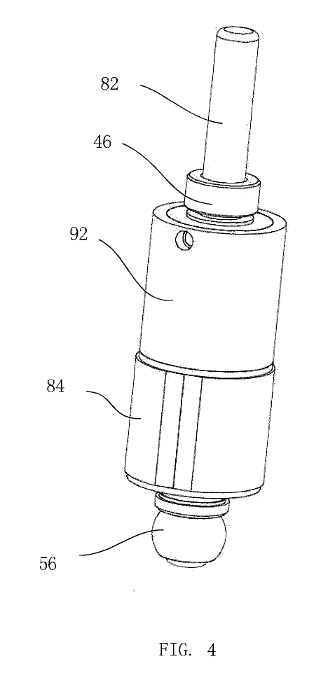

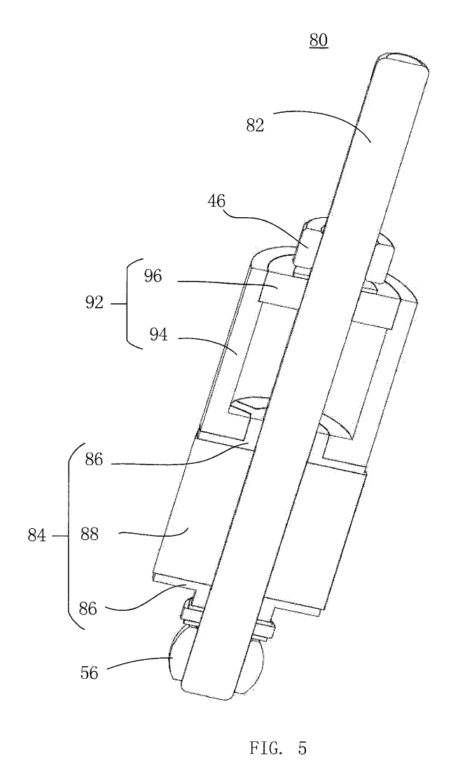

Referring to FIG. 4 and FIG. 5, in this embodiment, the rotor main body 84 includes a mounting member 86 and a permanent magnet 88 mounted to the mounting member 86. The mounting member 86 is attached and slide-fit around the rotary shaft 82, for mounting the magnet 88 to the shaft 82. In this embodiment, the mounting member 86 is made of plastic. Preferably, the mounting member 86 is directly formed on the permanent magnet 88 by insert-molding, such that the permanent magnet 88 and the mounting member 86 as a whole are slidable relative to the rotary shaft 82.

The time-delayed synchronization mechanism 92 includes a buffering member 94 and a connecting member 96. In this embodiment, the connecting member 96 is an annular plate fixed around the rotary shaft 82. A first end of the buffering member 94 is connected to the connecting member 96, such that the first end of the buffering member 94 is capable of synchronous rotation with the rotary shaft 82. It should be understood that the connection of the first end of the buffering member 94 to the connecting member 96 can be either a fixed connection or a movable connection. A second end of the buffering member 94 is connected to the rotary shaft 84 for synchronous rotation therewith. In this embodiment, the second end of the buffering member 94 is fixedly connected to the mounting member 86 (for example, the mounting member 86 can be directly formed on the second end of the buffering member 94 by insert-molding) for synchronous rotation with the rotor main body 84. The time-delay synchronization function of the time-delayed synchronization mechanism 92 is realized mainly by means of the buffering member 94, i.e. the buffering member 94 can eliminate, with time delay, the rotation speed difference between the rotor main body 84 and the rotary shaft 82. In particular, when the motor 200 begins starting, the rotor main body 84 rotates under the driving of the electromagnetic force formed between the rotor and the stator 20. The rotary shaft 82 is connected with the load so that the rotary shaft 82 has a large inertia, and the rotary shaft 82 has a sliding fit with the rotor main body 84. Therefore, during the period of start-up, the rotation speed of the rotor main body 84 is greater than the rotation speed of the rotary shaft 82, i.e. a rotation speed difference exists between the rotor main body 84 and the rotary shaft 82. This causes the buffering member 94 to be twisted by the rotor main body 84 and the rotary shaft 82 and, as a result, the rotation speed of the rotator main body 84 is eventually synchronous with the rotation speed of the rotary shaft 82. When the motor 10 stops from an operation state, due to the large rotational inertia of rotary shaft 82 and its load, the rotation speed of the rotary shaft 82 is greater than the rotation speed of the rotor main body 84. This causes the buffering member 94 to be twisted by the rotary main body 84 and the rotary shaft 82 and, as a result, the rotation speed of the rotator main body 84 is eventually synchronous with the rotation speed of the rotary shaft 82.

In this embodiment, the buffering member 94 is a rubber sleeve. It should be understood that it is not intended to limit the buffering member 94 to the rubber sleeve. In fact, any elastic/deformable member with a shape restoring function can be used as the buffering member 94 to synchronize, with time delay, the rotation speeds of the rotor main body 84 and the rotary shaft 82.

It should be understood that the connecting member 96 may not be necessary. In an alternative embodiment, one end of the buffering member 94 may be directly connected to the rotary shaft 82 for synchronous rotation therewith. It should also be understood that the connecting member 96 may be of another shape.

It should be understood that there may be two time-delay synchronization mechanisms 92 mounted to two ends of the rotor main body 84, respectively.

During the period of startup of the motor 200, the rotor main body 84 is rotatable relative to the rotary shaft 82 at the beginning and the rotary shaft 82 is then gradually synchronized with the rotor main body 84 by the time-delayed synchronization mechanism 92, which may reduce or eliminate startup failure of the motor 200 usually happened when a motor with a small output torque is used to drive a load with large rotational inertia. This design is suitable for single phase synchronous motors which usually has a relatively small output torque compared to multi-phase motors such as two/three phase motor.

### Second Embodiment

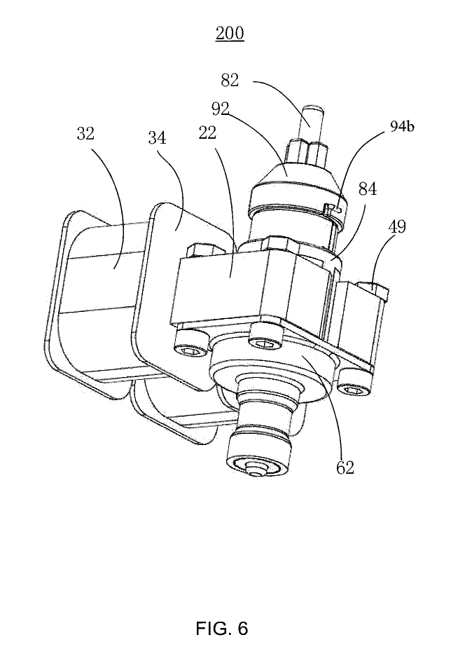

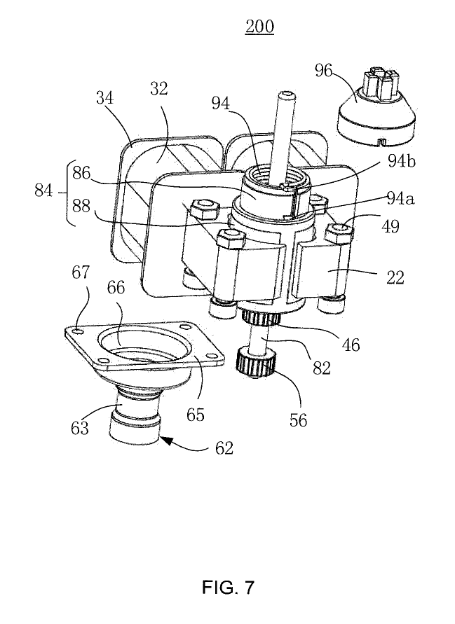

Referring to FIG. 6 and FIG. 7, one difference between the second embodiment and the first embodiment lies in the support structure of the rotor. In the previous embodiment, the stator 20 supports the rotary shaft 82 with the upper support bracket 42 and the lower support bracket 52. In this embodiment, the stator 20 supports the rotor 80 with only one support bracket 62. The support bracket 62 is fixed to one side of the stator core 22. The support bracket 62 includes a hollow cylindrical portion 63 and a mounting plate 65 at an open end of the cylindrical portion 63. The mounting plate 65 centrally defines a through hole 66 in communication with the hollow part of the cylindrical portion 63, for allowing the rotary shaft 82 and a portion of the rotor main body 84 to pass there through. The mounting plate 65 has a plurality of mounting holes 67 for allowing the fixing members 49 to pass there through, and is fixed to one side of the stator core 22 through the fixing members 49.

The cylindrical portion 63 includes two bearing seats for mounting two bearings 46, 56, respectively. The rotary shaft 82 of the rotor is supported by the bearings 46, 56 for rotation relative to the stator 20. The bearings 46, 56 are spaced apart by a predetermined distance. The rotor main body 84 and time-delayed synchronization mechanism 92 are located outside the cylindrical portion 63.

Another difference between the second embodiment and the first embodiment lies in the structure of the time-delayed synchronization mechanism 92. In this embodiment, the time-delayed synchronization mechanism 92 includes a connecting member 96 and a buffering member 94. The connecting member 96 is fixed around the rotary shaft 82. The buffering member 94 is preferably a helical spring having one end 94a connected to the mounting member 86 of the rotor main body 84 and the other end connected to the connecting member 96.

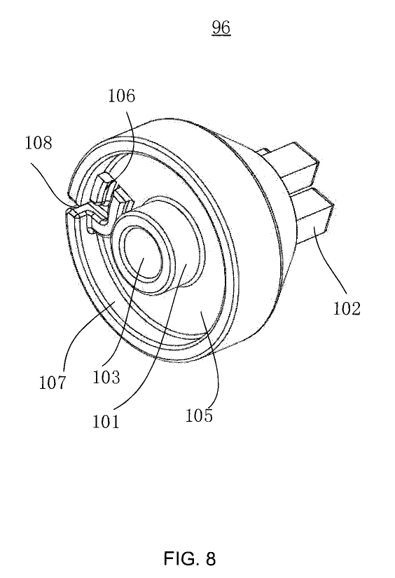

Referring to FIG. 7 and FIG. 8, the mounting member 86 of the rotor main body 84 has an opening or slot for connecting with one end 94a of the helical spring, and the connecting member 96 has an indentation 108 for connecting with the other end 94b of the helical spring. The buffering member 94 acts to eliminate, with time delay, the rotation speed difference between the rotor main body 84 and the rotary shaft 82. When the motor 10 begins starting, the rotor main body 84 rotates under the driving of the electromagnetic force formed between the rotor and the stator 20. The rotary shaft 82 is connected with the load such as a fan so that the rotary shaft 82 has a large inertia, and the rotary shaft 82 has a sliding fit with the rotor main body 84. Therefore, at beginning of startup, the rotation speed of the rotor main body 84 is greater than the rotation speed of the rotary shaft 82, i.e. a rotation speed difference exists between the rotor main body 84 and the rotary shaft 82. This causes the helical spring 94 to be pulled by the rotor main body 40, with its inner diameter gradually decreasing, such that the buffering member 94 is gradually tightened onto the rotary shaft 82 and the rotation speeds of the rotor main body 84 and the rotary shaft 82 are eventually synchronized. When the motor 200 stops from an operation state, the buffering member 94 deforms reversely, that is, the buffering member 94 is gradually loosened with its inner diameter gradually increasing, which allows a rotation speed difference exists between the rotor main body 84 and the rotary shaft 82.

Preferably, the mounting member 86 includes a cylindrical hollow portion for receiving the buffering member 94 and constraining the maximum diameter of the buffering member 94 (i.e. the helical spring) to prevent the helical spring from being damaged.

In this embodiment, the connecting member 96 has a cover shape and includes a central portion 101, a connecting portion 105 extending from the central portion 101, a sidewall 107 extending from the connecting portion 105. A surface of the connecting portion 105 is provided with two blocks which form a positioning slot 106 for receiving a distal end of the helical spring, and the sidewall 107 is preferably round and forms the indentation 108, adjacent the positioning slot 106, for receiving the distal end 94b of the helical spring. The central portion 101 has a through hole 103 to allow the rotary shaft 82 to extend through. An axial end of the central portion 101 away from the spring further includes a plurality of axially-extending limiting posts 102 which can be received in a connecting hole of the load. The limiting posts 102 surround an outer circumference of the through hole 103 for reinforcing the fixed connection between the load the rotary shaft 82.

In this embodiment, the buffering member 94 is a spring. It should be understood that it is not intended to limit the buffering member 94 to the spring. In fact, any elastic member with a shape restoring feature can be used as the buffering member 94 to synchronize, with time delay, the rotation speeds between the rotor main body 84 and the rotary shaft 82.

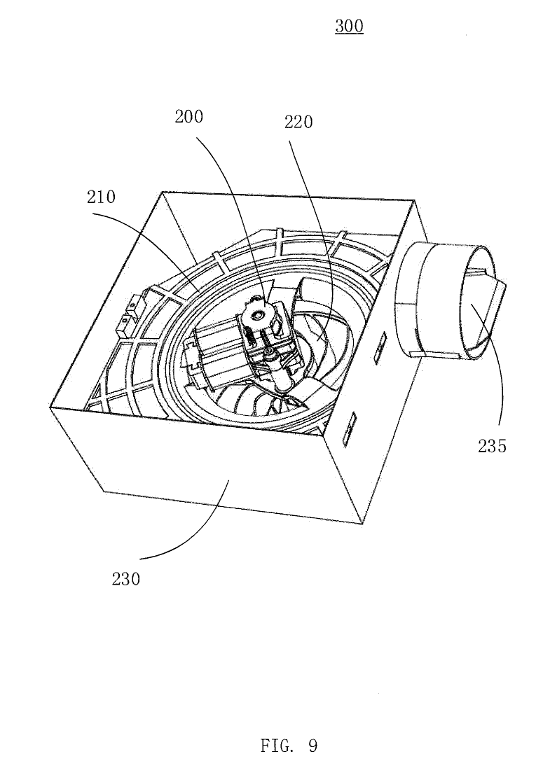

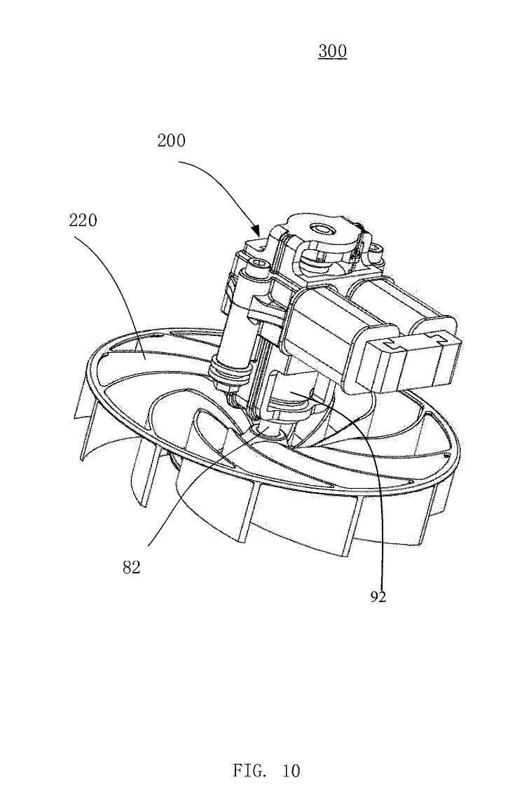

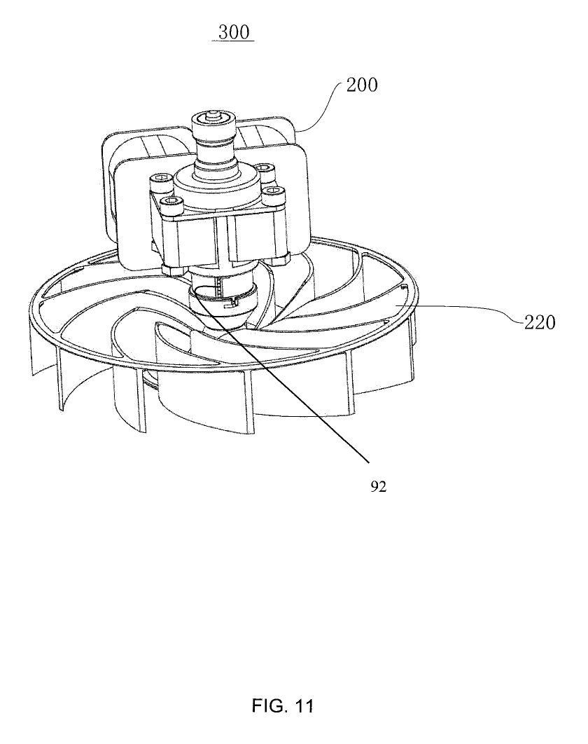

FIG. 9 illustrates a fan assembly 300 using the motor of the present invention. Referring to FIG. 9, FIG. 10 and FIG. 11, the fan assembly 300 includes a frame 210, a motor 200 mounted to the frame 210, and a fan 220 mounted to a rotary shaft 82 of the motor 200. The frame 210 is mounted to a housing 230. The housing 230 forms an air passage, and an outlet 235 of the air passage is formed on the housing 230.

In this embodiment, an outer diameter of the fan 220 is significantly greater than the size of the motor 200 perpendicular to the rotary shaft of the rotor. The area occupied by the fan 220 perpendicular to the rotary shaft of the rotor is greater than twice, preferably three or four times of the area occupied by the motor 200 perpendicular to the rotary shaft of the rotor. The time-delayed synchronization mechanism 92 mounted in the motor 200 can effectively reduce or eliminate startup failure or stall of the motor 200.

### Third Embodiment

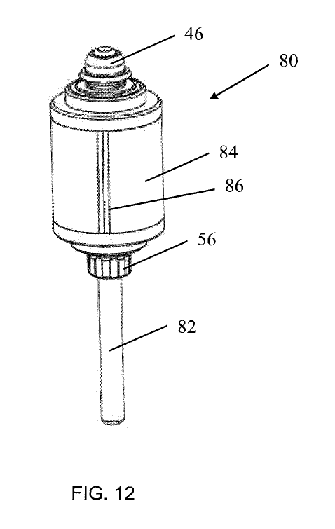

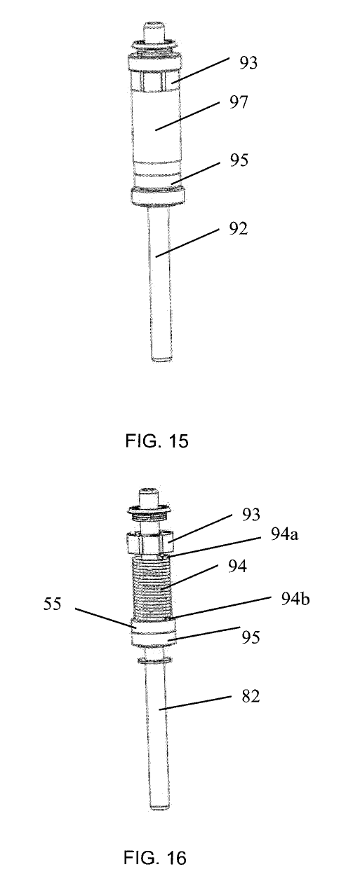

FIGS. 12 to 18 show a rotor of a motor in accordance with a third embodiment of the present invention. The stator of the motor can adapt the stators of the above mentioned embodiments.

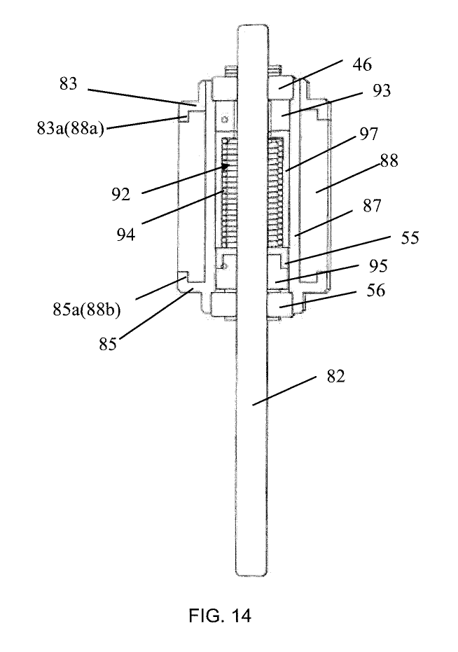

Referring to FIG. 12, the rotor 80 includes a rotary shaft 82, a rotor main body 84, and a time-delayed synchronization mechanism 92 (shown in FIG. 14). The rotor main body 84 is attached around the rotary shaft 82. Two bearings 46, 56 are mounted outside two ends of the rotor main body 84, respectively. The rotary shaft 82 is supported by the two bearings 46, 56 so as to be rotatable relative to the rotor main body 84. The rotor main body 84 has a loose fit such as a slidable fit with the rotary shaft 82 and, as a result, the rotor main body 84 and the rotary shaft 82 may have a significant rotation speed difference during the course of startup or stopping.

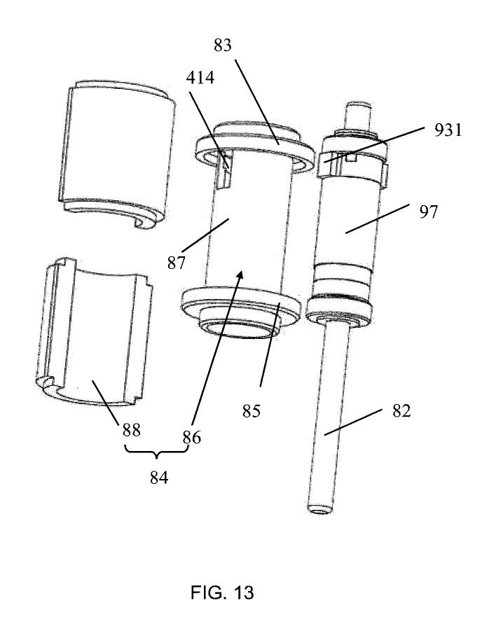

Referring to FIGS. 13-14, the time-delayed synchronization mechanism 92 is disposed within the rotor main body 84 and radially located between the rotor main body 84 and the rotary shaft 82. The time-delayed synchronization mechanism 92 is attached around the rotary shaft 82. The time-delayed synchronization mechanism 92 has a first end directly or indirectly connected to the rotor main body 84 so that the first end of the time-delayed synchronization mechanism 92 is capable of synchronous rotation with the rotor main body 84. A second end of the time-delayed synchronization mechanism 92 is directly or indirectly connected to the rotary shaft 82, so that the second end of the time-delayed synchronization mechanism 92 is capable of synchronous rotation with the rotary shaft 82. Therefore, the presence of the time-delayed synchronization mechanism 92 can synchronize with time delay the rotation speeds of the rotor main body 84 and the rotary shaft 82, which can effectively reduce or eliminate the occurrence of the startup failure or stall of the motor 100. In this embodiment, the time-delayed synchronization mechanism 92 is disposed in the interior of the rotor main body 84, without changing outside structures of the rotor 80 and the motor, and the load can be directly connected to one end of the rotary shaft 82, which results in a more compact structure of the motor 100 and facilitates repairmen and replacement of the motor 100.

In this embodiment, the rotor main body 84 includes a mounting member 86, permanent magnets 88. The mounting member 86 includes a hollow cylindrical main portion 87 and two sleeve rings 83, 85. The permanent magnet members 88 are mounted to an outer side of the main portion 87. The two sleeve rings 83, 85 are attached around two ends of the outer side of the main portion 87 for axially positioning the permanent magnet members 88. Specifically, the two rings 83, 85 have opposed grooves 83a, 85a. Two ends of the permanent magnet 88 form protrusions 88a, 88b corresponding to the grooves 83a, 85a. The protrusions 88a, 88b are engaged in the grooves 83a, 85a, such that the peinianent magnets 88 can be firmly positioned at the outer side of the main portion 87 of the mounting member 86. Preferably, the mounting member 86 and the sleeve rings 83, 85 are injection-molded over the permanent magnets 88.

Two bearings 46, 56 are respectively mounted within two ends of the main portion 87 of the mounting member 86. The bearings 46, 56 have a sliding fit with the rotary shaft 82, which allows the mounting member 86 to freely rotate relative to the rotary shaft 82 without producing too large jumping, while ensuring the reliability and lifespan of the motor.

In this embodiment, the time-delayed synchronization mechanism 92 includes a buffering member 94, a ring-shaped first connecting member 93, and a ring-shaped second connecting member 95. The buffering member 94 is surrounded on the shaft 82. The main portion 87 of the mounting member 86 surrounds an outer circumferential side of the buffering member 94 in order to protect the buffering member 94. A first end 94a of the buffering member 94 is connected to the first connecting member 93, a second end 94b of the buffering member 94 is connected to the second connecting member 95. The first connecting member 93 is movably attached around the rotary shaft 82, and the second connecting member 95 is fixedly attached around the rotary shaft 82. The first connecting member 93 and the second connecting member 95 are axially located at inner sides of the two bearings 46, 56 to axially position the two bearings 46, 56, which can prevent axial displacement of the rotor main body 84. The second connecting member 95 is fixedly connected to the rotary shaft 82, such that the second end of the buffering member 94 can rotate synchronously with the rotary shaft 82. The first connecting member 93 is fixedly connected to the mounting member 86 so as to rotate synchronously with the mounting member 86 and rotor main body 84. Therefore, the buffering member 94 is configured to buffer the rotation speed difference between the rotor main body 84 and the rotary shaft 82 at the startup or stopping of the motor. In this embodiment, the main portion 87 of the mounting member 86 has two cutouts 414 (FIG. 13) positioned symmetrically about an axis of the main portion 87. The first connecting member 93 includes two protruding blocks 931 corresponding to the cutouts 414. The protruding blocks 931 fit in the cutouts 414, such that the buffering member 94 can rotate synchronously with the rotor main body 84. It should be understood that the mounting member 86 can be connected with the first connecting member 93 through another structure.

The buffering member 94 includes an elastic member with a shape restoring characteristic. Preferably, the elastic member is a helical spring 94 loose/movably attached around the rotary shaft 82. When the winding of the stator is energized, the stator generates an electromagnetic field which drives the rotor main body 84 to rotate. One end of the rotary shaft 82 is connected with a load such as a fan so that the rotary shaft 82 has a large inertia, and the rotary shaft 82 has a sliding fit with the rotor main body 84. Therefore, at the beginning of startup, the rotation speed of the rotor main body 84 is greater than the rotation speed of the rotary shaft 82, i.e. a rotation speed difference exists between the rotor main body 84 and the rotary shaft 82. The first end 94a of the helical spring 94 is pulled and tightened by the rotation of the rotor main body 84 which results in the inner diameter of the spring gradually decreasing from the first end 94a toward the second end 94b. As a result, the second end 94b of the helical spring is also gradually tightened, and the rotation speed of the rotary shaft 82 is eventually synchronous with the rotation speed of the rotator main body 84. When the rotor stops from an operation state, because of the large rotational inertia of the load, the rotation speed of the rotary shaft 82 is greater than the rotation speed of the rotor main body 84, i.e. a rotation speed difference exists between the rotor main body 84 and the rotary shaft 82, such that the second end 94b of the helical spring 94 is gradually loosened with its inner diameter gradually increasing. As a result, the first end 94a of the helical spring is also gradually loosened, and the rotation speed of the rotator main body 40 is eventually synchronous with the rotation speed of the rotary shaft 82. The mounting member 86 surrounds the helical spring, which prevents the helical spring from being damaged due to over-increasing of its inner diameter.

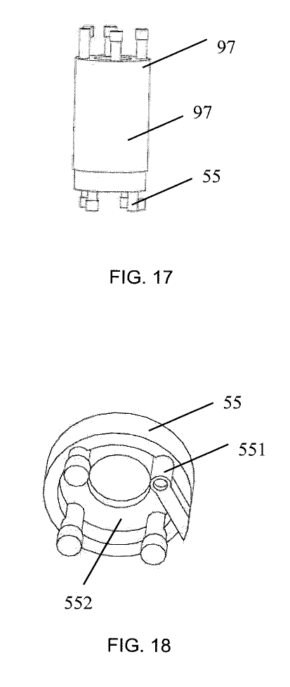

Preferably, the time-delayed synchronization mechanism 92 further includes a damping member 97. The damping member 97 is movably attached around the buffering member 94 and radially located between the buffering member 94 and the main portion 87 of the mounting member 86 for buffering the striking of the buffering member 94 to the main portion 87 of the mounting member 86, thereby achieving shock-absorbing and noise reduction results. One end of the damping member 97 is connected to the first connecting member 93. Referring also to FIG. 17, the damping member 97 includes a connecting pin structure 971. The first connecting member 93 includes a through-hole structure corresponding to the connecting pin structure 971, and the connecting pin structure 971 engages with the through-hole structure to reinforce the connection between the damping member 97 and the first connecting member 93 thus preventing the damping member 97 from being disengaged from the first connecting member 93. The other end of the damping member 97 is connected to, preferably fixedly connected to a connecting base 55. Referring to FIG. 17 and FIG. 18, the connecting base 55 is connected to the second connecting base 95. The connecting base 55 also includes a connecting pin structure 551 and a recessed portion 552. The second connecting member 95 includes a through-hole structure and a protruding portion corresponding to the connecting pin structure 551 and the recessed portion 552. The connecting pin structure 551 engages with the through-hole structure, and the protruding portion engages with the recessed portion 552, which reinforces the connection between the connecting base 55 and the second connecting member 95 thus preventing the damping member 97 from being disengaged from the second connecting member 95.

Preferably, the material of the damping member 97 and the connecting base 55 is a soft material such as rubber or foamed plastic.

It should be understood that, although the motor of the above mentioned embodiments particularly suitable for single-phase synchronous motors, the motor of the present invention may also be used in other applications where a small output torque motor drives a large load with a large rotational inertia.

The rotor main body 84 of the present invention preferably includes the permanent magnet. It should be understood that the present invention is also suitable for non-permanent magnet motors, i.e. the rotor main body 84 does not include permanent magnet but instead includes a plurality of conductors made of a soft magnetic material, the stator winding, upon being energized, generates an electromagnetic field, and the conductors are thereby magnetized and driven to rotate under the action of the electromagnetic fields.

Although the motors are illustrated as outer-stator motors in the above embodiments, it should be understood, however, that the present invention may also be suitable for inner-stator motors.

Although the invention is described with reference to one or more embodiments, the above description of the embodiments is used only to enable people skilled in the art to practice or use the invention. It should be appreciated by those skilled in the art that various modifications are possible without departing from the spirit or scope of the present invention. The embodiments illustrated herein should not be interpreted as limits to the present invention, and the scope of the invention is to be determined by reference to the claims that follow.

1. An electric motor comprising a stator and a rotor, the stator comprising a stator core and a winding wound on the stator core, the rotor rotatably mounted to the stator, the rotor comprising:
a rotary shaft;
a rotor main body attached around the rotary shaft, the rotor main body being rotatable under coaction between the rotor main body and the stator when the winding is energized, the rotor main body and the rotary shaft being in a loose fitting with each other to allow a rotation speed difference being existed between the rotor main body and the rotary shaft during startup of the rotor; and
a time-delayed synchronization mechanism connected between the rotary shaft and the rotor main body and configured to eliminate the rotation speed difference between the rotor main body and the rotary shaft with time delayed.

2. The electric motor of claim 1, wherein the time-delayed synchronization mechanism is radially located between the rotary shaft and the rotor main body.

3. The electric motor of claim 1, wherein the time-delayed synchronization mechanism is located axial outside of the rotor main body.

4. The electric motor of claim 1, wherein the time-delayed synchronization mechanism includes a buffering member with a shape restoring characteristic, the buffering member comprising a first end connected to the rotary shaft for synchronization rotation with the rotary shaft and a second end connected to the rotor main body for synchronization rotation with the rotor main body.

5. The electric motor of claim 4, wherein the time-delayed synchronization mechanism further comprises a connecting member fixed to the rotary shaft, and the first end of the buffering member is connected to the connecting member for synchronous rotation therewith.

6. The electric motor of claim 5, wherein the connecting member is an annular plate fixed around the rotary shaft, and the buffering member is movably attached around the rotary shaft and is axially located between the connecting member and the rotor main body.

7. The electric motor of claim 4, wherein the buffering member is a rubber sleeve or spring movably attached around the rotary shaft.

8. The electric motor of claim 1, wherein there are two time-delay synchronization mechanisms mounted to opposite ends of the rotor main body, respectively.

9. The electric motor of claim 1, wherein the rotary shaft is rotatably supported by two bearings which are mounted in the stator, the rotor main body and the time-delayed synchronization mechanism are axially located between the bearings or outside the two bearings.

10. The electric motor of claim 1, wherein
the rotor main body comprises a permanent magnet; or
the rotor main body comprises a rotor core and a permanent magnet fixed to the rotor core; or
the rotor main body comprises a rotor core and conductors fixed to the rotor core.

11. The electric motor of claim 10, wherein the rotor main body further comprises a mounting member movably attached around the rotary shaft, and the permanent magnet or rotor core is fixed to the mounting member.

12. The electric motor of claim 1, wherein the motor is a single phase motor.

13. The electric motor of claim 1, wherein the stator comprises an upper support bracket and a lower support bracket, the rotary shaft is supported by the upper support bracket and the lower support bracket for rotation relative to the stator, and the rotor main body and the time-delayed synchronization mechanism are located between the upper support bracket and the lower support bracket.

14. The electric motor of claim 13, wherein the stator comprises a stator core and a stator winding mounted around the stator core, the stator core comprises at least two pole portions, the rotor main body is disposed in a space cooperatively defined by the at least two pole portions, and the upper support bracket and the lower support bracket are mounted to two axial sides of the stator core, respectively.

15. The electric motor of claim 5, wherein the buffering member is a helical spring, the rotor main body comprises a cylindrical hollow portion for receiving the spring therein.

16. The electric motor of claim 15, wherein the connecting member defines a groove or slot for engaging with a first end of the helical spring, and the rotor main body defines another groove or slot for engaging with a second end of the helical spring.

17. The electric motor of claim 2, wherein the time-delayed synchronization mechanism comprises a buffering member movably attached around the rotary shaft, and a damping member movably attached around the buffering member, the damping member being radially located between buffering member and the rotor main body.

18. The electric motor of claim 17, wherein the rotor main body comprises permanent magnets and a support member for supporting the permanent magnets thereon, the buffering member and the damping member being located within the support member.

19. A fan assembly comprising a fan and an electric motor, the electric motor comprising:
a stator comprising a stator core and a winding wound on the stator core; and
a rotor rotatably mounted to the stator, the rotor comprising:
a rotary shaft connected to the fan for driving the fan to synchronization rotate with rotary shaft;
a rotor main body attached around the rotary shaft, the rotor main body and the rotary shaft being in a loose fit with each other thus allowing a rotation speed difference therebetween; and
a time-delayed synchronization mechanism located between the rotor main body and the rotary shaft, one end of the time-delayed synchronization mechanism being connected to the rotor main body, and the other end of the time-delayed synchronization mechanism being connected to the rotary shaft, for synchronizing with time delay rotation speeds of the rotor main body and the rotary shaft.

20. The fan assembly of claim 19, wherein the motor is a single phase motor, and the area occupied by the fan in a plane perpendicular to the rotary shaft of the rotor is greater than twice of the area occupied by the motor in another plane perpendicular to the rotary shaft of the rotor.
